(19) United States
(12) Patent Application Publication
(10) Pub. No.: US 2010/0136866 A1
(43) Pub. Date: Jun. 3, 2010

(54) LAMINATED COMPOSITES AND METHODS OF MAKING THE SAME

(75) Inventors: Choongyong Kwag, Troy, MI (US); Chen-Shih Wang, Troy, MI (US)

Correspondence Address: Julia Church Dierker;Dierker & Associates, P.C., 3331 W. Big Beaver Road, Suite 109, Troy, MI, 48084-2813, US

(73) Assignee: GM GLOBAL TECHNOLOGY OPERATIONS, INC., Detroit, MI (US)

(21) Appl. No.: 12/326,362

(22) Filed: Dec. 2, 2008

(51) Int. Cl. B32B 5/26; D03D 25/00; D04H 13/00; B32B 38/08; B05D 3/00

(52) U.S. Cl. 442/239; 428/221; 428/332; 442/268; 442/181; 442/327; 442/381; 156/313; 427/565

(57) ABSTRACT

The instant disclosure relates to a laminated composite and methods of making the same. The laminated composite includes a plurality of stacked prepregs having an interface formed between each pair of adjacent prepregs. Each prepreg includes a matrix material and reinforcing fibers dispersed therein. The laminated composite also includes at least one fibrous veil laminated to at least a portion of at least one of the interfaces, the at least one fibrous veil having nanofibers attached to at least one surface thereof. Also disclosed herein are a fibrous veil and a method of making the nanofiber-doped fibrous veil.

### TECHNICAL FIELD

The present disclosure relates generally to laminated composites and methods of making the same, and more particularly to laminated composites made with prepregs and fiber veils having nanofibers attached thereto.

### BACKGROUND

Laminated composites made with carbon fiber-epoxy prepregs have been used for many applications. Enhanced impact properties of such laminated composites may be particularly desirable for certain automotive and engineering applications. Efforts to improve the impact properties of laminated composites include modifying the matrix resin properties or the laminate structure. The former is accomplished primarily by toughening the prepreg resin system utilizing appropriate toughening materials. The latter has been attempted by incorporating various interfaces between layers using smaller scale fibers.

### SUMMARY

The instant disclosure relates to a laminated composite and methods of making the same. The laminated composite includes a plurality of stacked prepregs having an interface formed between each pair of adjacent prepregs. Each prepreg includes a matrix material and reinforcing fibers dispersed therein. The laminated composite also includes at least one fibrous veil laminated to at least a portion of at least one of the interfaces, the at least one fibrous veil having nanofibers attached to at least one surface thereof. Also disclosed herein are a fibrous veil and a method of making the nanofiber-doped fibrous veil.

### BRIEF DESCRIPTION OF THE DRAWING

Features and advantages of the present disclosure will become apparent by reference to the following detailed description and drawings.

FIG. 1 is a graph of comparative displacement curves plotting Load (kN) vs. Displacement (mm) from a sample of the laminated composite disclosed herein and multiple comparative samples; and

FIGS. 2A, 2B and 2C are a series of three schematic diagrams illustrating the steps of dispersing carbon nanofibers (labeled “CNF Dispersing” in FIG. 2A), doping a veil with carbon nanofibers (labeled “CNF Doping” in FIG. 2B), and performing laminate molding (labeled “Laminate Molding” in FIG. 2C).

### DETAILED DESCRIPTION

The laminated composite disclosed herein exhibits superior impact properties when compared to other known laminated composites. The composite of the examples disclosed herein includes small amounts of nanofibers strategically placed at the interfaces between multiple prepreg layers. These small amounts of nanofibers are attached to thin fibrous veils, which are used as carriers for the nanofibers. These thin fibrous veils carrying the nanofibers are placed at the interfaces between the prepreg layers. The nanofiber-doped fibrous veils advantageously increase the impact properties of the resulting composite, without substantially increasing the thickness of the composite.

The term “prepreg”, as used herein, is a combination of matrix resin and fiber reinforcement which is ready for use in the manufacturing process disclosed herein under heat and pressure. In one example, the fibers of the prepreg have been impregnated with a pre-catalyzed matrix resin and partially cured (B-stage). A “lay-up” refers to the procedure of laying the prepreg, which has been pre-impregnated with the resin, outside or sometimes directly onto the mold. It is to be understood that in the method disclosed herein, the lay-up procedures also involve laying the nanofiber-doped veil (discussed further hereinbelow) between the prepregs.

In preparing the laminated composite disclosed herein, the lamination of the nanofiber-doped veils onto the prepregs takes place during the lay-up process. One advantage of this technique is that it does not require any chemical or physical modifications of the existing prepregs. Modifying commercial prepregs is generally difficult and costly, at least in part because these materials are delicately balanced in their cure rate, viscosity-temperature behavior, and handling characteristics. It is to be understood that the method of making the laminated composite disclosed herein may be used with any prepreg. The technique is believed to be practical for implementation since it requires minimal, if any, alteration of the conventional prepregs and/or of the lay-up processes.

Another advantage of the method disclosed herein is that it uses a significantly smaller amount of the nanofibers, compared with the traditional methods of incorporating nanofibers into the entire prepreg resin matrix. For example, a previous study found in literature (see FIG. 12 in Quaresimin et al., “Understanding the effect of nano-modifier addition upon the properties of fibre reinforced laminates,” Composites Science and Technology, Volume 68, Issues 3-4, March 2008, Pages 718-726) reported a 20% improvement in impact energy by adding 7.5 wt % of carbon nanofibers (CNF) to the prepreg itself. The technique of the present disclosure generates more than 20% improvement with less than 2 wt % of CNF, and without having to incorporate the CNF into the prepreg composition, as shown in Tables 1 and 2 in the examples hereinbelow.

Still another advantage of the method disclosed herein is that any increases in thickness and weight of the parts molded from the laminated composite resulting from the process disclosed herein are minimal and likely negligible. For example, the thickness of the molded composite may be increased by about 0.01 mm to about 0.1 mm by including the doped veils. Therefore, the method disclosed herein is applicable without having to modify existing part design and manufacturing tooling and processes.

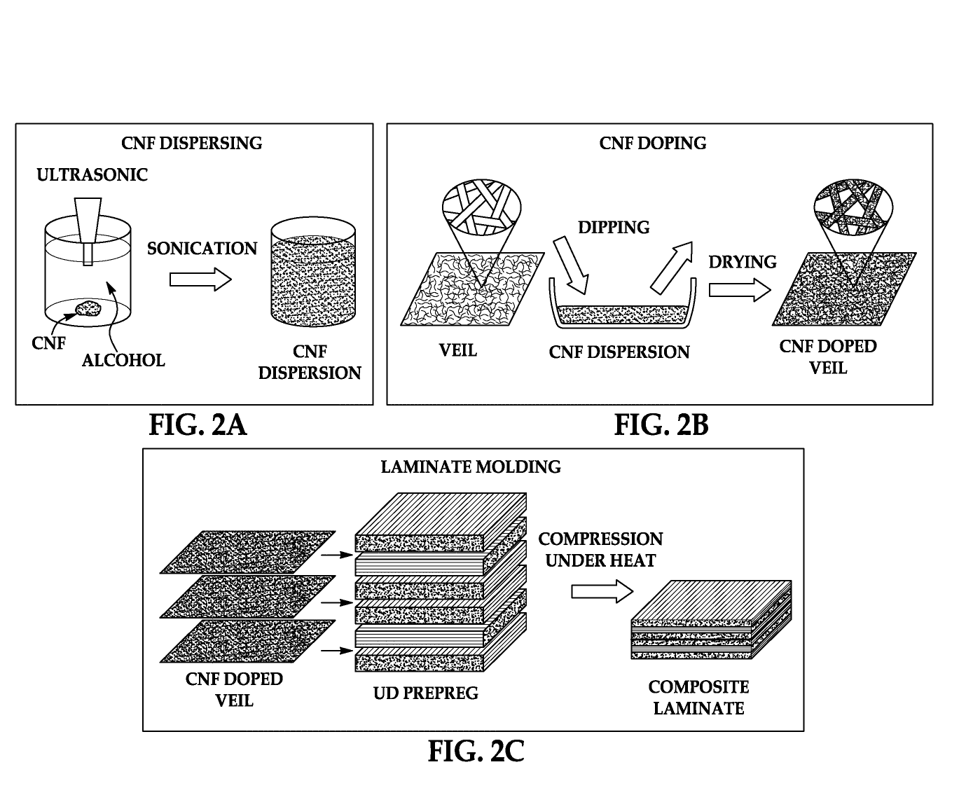

Generally, as shown in FIG. 2A, the method begins by dispersing a small amount of suitable nanofibers having diameters ranging from about 60 nm to about 200 nm into a desirable solvent or solution. The small amount of nanofibers dispersed in the solvent generally ranges from about 0.5 to about 2 weight percent of nanofibers in the solvent. The amount chosen is such that the nanofibers disperse to achieve the desirable solution, and such that the resulting solution facilitates substantially even distribution of the nanofibers onto the fibrous veil. Furthermore, it is to be understood that the amount of nanofibers used may be varied, depending, at least in part, on the desirable enhanced level of the impact properties.

Non-limiting examples of suitable nanofibers include oxidized and non-oxidized carbon nanofibers, nanoscale carbon whiskers, polymeric nanofibers, ceramic nanofibers, and metallic nanofibers. Such nanofibers may be pre-grown, synthesized, or spun nanowires; naturally deposited minerals having a nanoscale fiber or tubular structure that are commercially available; or may be fabricated as part of the method disclosed herein (e.g., via vapor growth processes). For example, carbon nanofibers may be grown by catalytic chemical vapor depositions of a range of hydrocarbons (such as methane, ethylene, propane, acetylene, benzene, natural gas, etc.) over a catalyst surface made of metal or metal alloy (such as iron, nickel, gold, cobalt, nickel-copper, iron-nickel, etc.). The vapor growing process is a typical method to produce carbon nanofibers which includes feeding a mixture of hydrocarbon, metal catalyst, and co-catalyst to a gas phase reactor.

In one example, the total amount of nanofibers in the final molded composite is generally less than 2 wt % of an amount of the total matrix material in the final molded composite. For example, if three doped veils include 2 wt % of the total nanofibers in the composite resin matrix, then each veil contains about 0.7 wt % of nanofibers with respect to the total amount of matrix resin used.

Since it is desirable that the nanofibers be dispersed in the selected solvent or solution, the solvent/solution selected will depend, at least in part, on the nanofibers being used. In a non-limiting example, isopropyl alcohol is a suitable solvent for dispersing oxidized carbon nanofibers. In another non-limiting example, other solvents that may be used include acetone, dimethylformamide, methanol, and ethanol. In another non-limiting example, isopropyl alcohol, a suitable solvent, a colloidal nanosilica/isopropanol solution, and a suitable dispersant may be mixed together and used as a suitable solution for dispersing non-oxidized carbon nanofibers. It is to be understood that some dispersion aids may also be used with the solvents to assist in dispersing the non-oxidized carbon nanofibers. These dispersion aids may include dimethylsulfoxide, N-methyl-2-pyrrolidone, and TRITON®-X100 (i.e., a nonionic surfactant which has a hydrophilic polyethylene oxide group).

The dispersion of the nanofibers in the selected solvent/solution may be accomplished by adding the nanofibers to the solvent/solution and exposing the mixture to sonication for a predetermined time. It is to be understood that the sonication time depends, at least in part, on the nanofibers and solvent/solution used. The temperature of the sonication bath is not strictly controlled, but the solution is kept relatively cool to prevent overheating by sonication. Such overheating may lead to rapid evaporation of the solvent and deterioration of the dispersion efficiency. The sonication time is determined, at least in part, by the nanofibers' dispersibility into the solvent or solution selected. The sonication time may also depend upon the maximum duration that the dispersed state may be maintained before phase separation begins.

Referring now to FIG. 2B, thin fibrous veils are dipped into the nanofiber-dispersed solution, thereby doping the veils with the nanofibers. One non-limiting example of a fibrous veil is a glass, carbon, or polymeric fibrous veil. The veils are allowed to soak for a predetermined time in the nanofiber-dispersed solution such that the nanofibers adhere to one or more exposed surfaces of the veil. The doped veil(s) is/are then dried. Drying can be accomplished by evaporating the solvent for a predetermined time at a predetermined temperature (a non-limiting example of which is room temperature).

The dried doped veil(s) is/are laminated at an interface between adjacent prepregs using standard lay-up procedures. As previously mentioned, any desirable prepreg may be used. In one example, the prepregs are unidirectional carbon fiber/epoxy prepregs including at most 35 wt % epoxy resin and at least 65 wt % carbon fibers. In terms of fiber structure, prepregs made of woven fabrics (such as plain, satin, twill, etc.), or multi-axial fabrics (such as non-crimp) may be used. Non-limiting examples of suitable prepreg fiber materials include carbon, glass, boron, and polymers. The carbon fibers in the prepregs may be, for example, 12K carbon fibers or 24K carbon fibers. Non-limiting examples of suitable prepreg matrix resins include epoxy resins, phenolic resins, polyester resins, vinyl ester resins, polyimide resins, thermoplastic resins, etc.

After being laminated together, the prepregs having the doped veil between the interfaces are molded into a composite part, using, for example, compression molding techniques (see, for example, FIG. 2C). Other non-limiting examples of suitable molding techniques include the vacuum bag process and the autoclave process.

To recap, in FIGS. 2A through 2C, there are provided schematic drawings of a) CNF being dispersed in alcohol by sonication; b) a fibrous veil being dipped in the CNF dispersion and then dried; and c) CNF doped veils being placed in the interfaces between several layered unidirectional (UD) prepregs, and the UD prepreg/veil structure subsequently being compressed under heat.

In the examples disclosed herein, the average diameter of the fibers making up the fibrous veils (not to be confused with the attached nanofibers) is the same or similar to the average diameter of the fibers making up the prepregs. In one example, the average diameter of the fibers in the veils and the prepregs ranges from about 7,000 nm to about 9,000 nm. Such fibers are generally commercially available, and, in some instances, may be more desirable. It is to be understood that the fibrous veils may be made with smaller fibers, but, in some instances, such veils may be more difficult to prepare and more costly.

To further illustrate the example(s) disclosed herein, the following examples are given. It is to be understood that these examples are provided for illustrative purposes and are not to be construed as limiting the scope of the examples disclosed herein.

### EXAMPLES

Molded panel samples were prepared according to the method disclosed herein (some with oxidized nanofibers (Samples 2 and 3) and some with non-oxidized nanofibers (Sample 1)), and two comparative molded panel samples were prepared, one of which included no veils (Comparative Example 1), and the other of which included un-doped veils (Comparative Example 2).

The sample composites according to the method disclosed herein were made as follows. The nanofibers used were non-oxidized (PR-24-LHT-LD) and oxidized (PR-24-XT-PS-OX) vapor grown carbon nanofibers supplied by Applied Sciences. To prepare the carbon nanofiber (CNF) containing veils, up to 2 g of the oxidized fibers were dispersed into 125 ml to 175 ml of isopropyl alcohol by sonicating for 1 hour in an ice-water cooling bath. The same amount of non-oxidized fibers was used in the same amount of isopropyl alcohol. In order to disperse the non-oxidized CNF in isopropyl alcohol, however, 0.5 g of TRITON®-X100 dispersant by Calbiochem and 0.6 g of IPA-ST colloidal nanosilica/isopropanol solution by Nissan Chemical (30 wt % silica) were added to the isopropyl alcohol before sonicating.

The dispersed solutions were transferred to respective square basins and fibrous veils (Optimat 20103A (glass fiber, 17 g/m²) supplied by TFP) were dipped into, and then taken out of the respective basins. The wet veils were dried by evaporating the alcohol for about 30 minutes at room temperature. The dry CNF-containing veils were then weighed.

The unidirectional carbon fiber-epoxy prepregs used in these examples consisted of 35 wt % of resin and 65 wt % of either 12K or 24K T700 carbon fibers, supplied by Patz Materials and Technologies. The aerial weight of the prepregs was 300 g/m².

Standard lay-up procedures were applied, and the lay-up arrangements were 0/90/0/0/90/0 for Comparative Example 1 and 0/V/90/0/V/0/90/V/0 for samples including veils (V=veil) (Samples 1, 2, 3 and Comparative Example 2). Each of the laid-up composite samples was compression molded in a picture frame (254 mm×254 mm) and two flat plates at 0.4 MPa and 157° C. for 10 minutes. The nominal thickness of the molded panel composites with veils (i.e., Samples 1, 2, 3 and Comparative Example 2) was about 1.85 mm and the nominal thickness of the molded panel composites without veils (i.e., Comparative Example 1) was 1.80 mm. The weight increases caused by adding veils and CNF were less than 2.2 wt % of the composite panels.

Square specimens (100 mm×100 mm) were then cut from the laminated composite panels for impact testing. The impact tests were performed using a high-rate Instron machine equipped with a hemispherical impact plunger (20 mm in diameter). The impact speed of 0.5 m/sec was selected to provide enough energy to penetrate specimens after preliminary tests. From the load-displacement curve, the maximum load was found and the corresponding energy was calculated by numerical integration under the curve for each sample. The energy to penetration was obtained by integration to the penetration point beyond which the oscillation of the load is still present, but as a representation of hinge effects. The impact testing was videotaped at the back side of the sample using a high speed video camera to confirm the interpretation of the load-displacement curve.

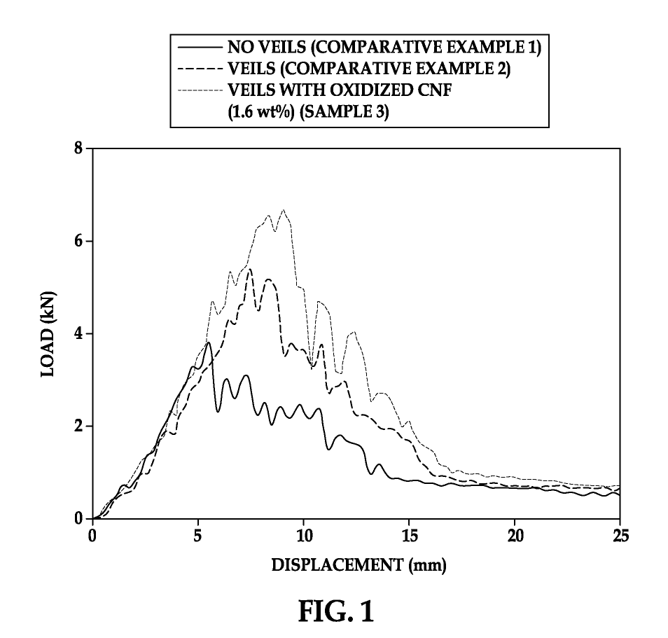

Three typical load-displacement curves obtained from the impact tests are shown in FIG. 1. The graph depicts Load (in kilo Newtons) vs. Displacement (in millimeters) for samples without veils (Comparative Example 1), samples with veils alone (Comparative Example 2) and samples with veils having oxidized CNF (1.6%, Sample 3). The numbers used for the Samples and Comparative Examples are averaged from 2 to 3 of the same or similar samples with at least two tests having been performed for each sample. The impact curve for the sample panel without fibrous veils (Comparative Example 1) was adjusted slightly higher to take into account the thickness increase (0.05 mm or 3%) caused by the addition of veils in the other samples. It was found that the addition of CNF onto the veils did not cause any measurable thickness change when compared to Comparative Example 2 (veil without CNF). The data indicates that the overall impact behavior of the samples was not altered by the addition of veils (either with or without CNF). However, the maximum load and impact energy were markedly increased for Comparative Example 2 containing the undoped fibrous veils only and further increased for Sample 3, containing fibrous veils doped with oxidized CNF.

The improvement in impact properties of the laminated composites including various amounts of CNF is summarized in Tables 1 and 2 (below) in terms of percent increase in maximum load, energy to maximum load, and energy to penetration. The concentration of CNF was calculated as a weight percent of the total resin matrix in the composite samples. The results show that the method disclosed herein successfully achieved significant enhancement in impact properties of laminated composites.

TABLE 1
Impact properties of laminated composites (12K, T700 carbon
fiber): Comparative Example 1 with no veils, Comparative Example 2
with veils having no CNF, Sample 1 with veils having non-oxidized CNF
and Samples 2 and 3 with veils having oxidized CNF

| | | | | Energy to | | Energy to | |
|---|---|---|---|---|---|---|---|
| | | Max. Load | | Max. Load | | Penetration | |
| | CNF in | | % | | % | | % |
| | resin % | kN | increase | J | increase | J | increase |
| Comparative | 0.0 | 4.0 | 0 | 10.9 | 0 | 30.6 | 0 |
| Example 1 | | | | | | | |
| Comparative | 0.0 | 5.3 | 32 | 19.6 | 80 | 41.9 | 37 |
| Example 2 | | | | | | | |
| Sample 1 | 0.8 | 5.5 | 37 | 25.1 | 131 | 47.1 | 54 |
| Sample 2 | 0.5 | 5.9 | 47 | 26.2 | 140 | 47.9 | 57 |
| Sample 3 | 1.6 | 6.5 | 63 | 29.5 | 170 | 53.5 | 75 |

TABLE 2
Impact properties of laminated composites (24K, T700 carbon
fiber): Comparative Example 1 with no veils, Comparative Example 2
with veils having no CNF, Sample 1 with veils having non-oxidized CNF
and Samples 2 and 3 with veils having oxidized CNF

| | | | | Energy to | | Energy to | |
|---|---|---|---|---|---|---|---|
| | | Max. Load | | Max. Load | | Penetration | |
| | CNF in | | % | | % | | % |
| | resin % | kN | increase | J | increase | J | increase |
| Comparative | 0.0 | 2.7 | 0.0 | 7.4 | 0.0 | 19.3 | 0.0 |
| Example 1 | | | | | | | |
| Comparative | 0.0 | 3.7 | 37 | 10.3 | 39 | 25.1 | 30 |
| Example 2 | | | | | | | |
| Sample 1 | 1.1 | 4.4 | 65 | 12.0 | 67 | 27.6 | 47 |
| Sample 2 | 0.8 | 4.1 | 55 | 13.5 | 87 | 31.0 | 65 |
| Sample 3 | 1.5 | 3.8 | 42 | 11.7 | 63 | 30.9 | 65 |

While several examples have been described in detail, it will be apparent to those skilled in the art that the disclosed examples may be modified. Therefore, the foregoing description is to be considered exemplary rather than limiting.

1. A laminated composite, comprising:
a plurality of stacked prepregs having an interface formed between each pair of adjacent prepregs, each prepreg including a matrix material and reinforcing fibers dispersed therein; and
at least one fibrous veil laminated to at least a portion of at least one of the interfaces, the at least one fibrous veil having nanofibers attached to at least one surface thereof.

2. The laminated composite of claim 1 wherein the at least one fibrous veil having the nanofibers attached thereto adds a predetermined thickness to the composite.

3. The laminated composite of claim 2 wherein the predetermined thickness ranges from about 0.01 mm to about 0.1 mm.

4. The laminated composite of claim 1 wherein the nanofibers are selected from the group consisting of oxidized carbon nanofibers, non-oxidized carbon nanofibers and combinations thereof.

5. The laminated composite of claim 1 wherein the reinforcing fibers are carbon fibers and the matrix material is a resin, wherein each of the prepregs includes at most 35 weight % of the resin and at least 65 weight % of the carbon fibers, and wherein the carbon fibers are selected from the group consisting of 12K carbon fibers, 24K carbon fibers and combinations thereof.

6. The laminated composite of claim 1 wherein the at least one fibrous veil is a glass fibrous veil.

7. The laminated composite of claim 1 wherein an amount of the nanofibers in the laminated composite is less than 2 wt. % of an amount of total matrix material in the laminated composite.

8. The laminated composite of claim 1 exhibiting an increase in at least one of maximum load, energy to maximum load, and energy to penetration.

9. The laminated composite of claim 1 wherein each of i) the plurality of prepregs and ii) the at least one fibrous veil includes fibers, wherein such fibers have the same or similar average diameters, and wherein the average diameter ranges from about 7000 nm to about 9000 nm.

10. The laminated composite of claim 1 wherein each of the plurality of prepregs includes i) fibers selected from carbon fibers, glass fibers, boron fibers, and polymeric fibers, ii) a structure selected from a unidirectional structure, woven fabrics, and multi-axial fabrics, and iii) a resin selected from epoxy resins, phenolic resins, polyester resins, vinyl ester resins, polyimide resins, and thermoplastic resins.

11. A method of making an impact-resistant laminated composite, the method comprising:
doping a surface of at least one fibrous veil with nanofibers;
laminating the at least one fibrous veil to at least a portion of an interface between a plurality of prepregs, each prepreg including reinforcing fibers in a matrix material; and
molding the laminated plurality of prepregs into the composite.

12. The method of claim 11 wherein the reinforcing fibers are carbon fibers and the matrix material is a resin, wherein each of the prepregs includes at most 35 weight % of the resin and at least 65 weight % of the carbon fibers, and wherein the carbon fibers are selected from the group consisting of 12K carbon fibers, 24K carbon fibers and combinations thereof.

13. The method of claim 11 wherein the nanofibers are selected from the group consisting of oxidized carbon nanofibers, non-oxidized carbon nanofibers, polymeric nanofibers, ceramic nanofibers, metallic nanofibers, and combinations thereof.

14. The method of claim 11 wherein the nanofibers are carbon nanofibers, and wherein doping the surface of the at least one fibrous veil with the carbon nanofibers is accomplished by:
dipping the at least one fibrous veil in a solution containing the carbon nanofibers dispersed therein; and
drying the at least one fibrous veil having the arbon nanofibers attached thereto.

15. The method of claim 14 wherein the carbon nanofibers are oxidized fibers and wherein the solvent is selected from the group consisting of isopropyl alcohol, acetone, dimethylformamide, methanol, ethanol, and combinations thereof.

16. The method of claim 14 wherein the carbon nanofibers are non-oxidized fibers and wherein the solution includes isopropyl alcohol, a dispersant, and a mixture of colloidal nanosilica and isopropanol.

17. A fibrous veil, comprising:
a base including a plurality of fibers, each of the plurality of glass fibers having an average diameter ranging from about 7,000 nm to about 9,000 nm; and
at least one of oxidized and non-oxidized carbon nanofibers attached to at least some of the plurality of glass fibers, wherein the carbon nanofibers have an average diameter ranging from about 60 nm to about 200 nm.

18. The fibrous veil as defined in claim 17 wherein the plurality of fibers in the base are selected from glass fibers, carbon fibers, and polymeric fibers.

19. A method of making a nanofiber-doped fibrous veil, the method comprising:
dispersing at least one of oxidized carbon nanofibers and non-oxidized carbon nanofibers into a solution by sonication;
dipping at least one fibrous veil into the dispersed carbon nanofiber solution; and
drying the at least one dipped veil at a predetermined temperature.

20. The method of claim 19 wherein the oxidized carbon nanofibers are used, and wherein the solution includes one of isopropyl alcohol, acetone, dimethylformamide, methanol, ethanol, or combinations thereof.

21. The method of claim 19 wherein the non-oxidized carbon nanofibers are used, and wherein the solution includes isopropyl alcohol, a dispersant, and a mixture of colloidal nanosilica and isopropanol.

22. The method of claim 22 wherein the dispersant is selected from the group consisting of dimethylsulfoxide, N-methyl-2-pyrrolidone, and a nonionic surfactant which includes a hydrophilic polyethylene oxide group.
